(19) United States
(12) Patent Application Publication
(10) Pub. No.: US 2003/0005130 A1
(43) Pub. Date: Jan. 2, 2003

(54) Audio-video management in UPnP

(76) Inventor: Doreen Yining Cheng, Los Altos, CA (US)

Correspondence Address: Corporate Patent Counsel, U.S. Philips Corporation, 580 White Plains Road, Tarrytown, NY, 10591, US

(21) Appl. No.: 09/895,964

(22) Filed: Jun. 29, 2001

(51) Int. Cl. G06F 15/16

(52) U.S. Cl. 709/228; 710/38

(57) ABSTRACT

To support the communication of audio-video information, and other time-sensitive information, via UPnP networks, the UPnP architecture is augmented to include: a resource management module that supports multiple contenders for a single device or its sub-units without races or hazards, a path manager that provides source-to-sink path management, and an action manager that enables A/V applications to schedule activities. Together, the resource manager and path manager ensure path validity, integrity, and quality of service. The resource manager is configured to manage device resources that are distributed in heterogeneous networks, such as resources distributed in networks using mixed Ethernet, 1394, 802.11, USB, HPNA. The path manager is configured to manage network resources that are distributed in heterogeneous networks. The resource manager and the path manager are also configured to ensure that a path across network boundaries is valid. Scheduling actions are the responsibility of each action manager, which acts as an agent of the application, and is a client of the resource manager and the path manager. The resource manager and the path manager are configured as an integral part of a UPnP framework, and as such, communicates with applications via HTTP messages.

### BACKGROUND OF THE INVENTION

1. Field of the Invention

This invention relates to the field of consumer products and home networking, and in particular to providing audio-video management capabilities to UPnP 1.0.

2. Description of Related Art

“Universal Plug and Play (UPnP) is an architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. Universal Plug and Play is a distributed, open networking architecture that leverages TCP/IP and the Web technologies to enable seamless proximity networking in addition to control and data transfer among networked devices in the home, office, and public spaces.”¹ 1 “Universal Plug and Play Device Architecture”, Version 1.0, Jun. 8, 2000, © 1999-2000 Microsoft Corporation, incorporated by reference herein.

Although UPnP provides for connectivity among a variety of devices in a home network, it is not well suited for the communication of audio-video information in a multiple application environment. Audio-video (AV) information transfer, for example from a VCR or DVD player to a television screen, typically requires a dedicated point-to-point communications channel with at least a given level of Quality-of-Service (QoS). With regard to the transfer of AV information, or other time-sensitive communications, UPnP1.0 has three main weaknesses.

The first weakness of UPnP is that it does not support multiple applications that may contend for control of the same device or its sub-units. As a result, when multiple applications try to change the state of a single device or its sub-units, race conditions can occur and the effect seen by the applications may be non-deterministic.

The second weakness is that UPnP leaves the burden of ensuring quality of service (QoS), which includes stream management, to the applications. As a result, an application with real time requirements must directly manage network resources. For example, a UPnP application must setup the connections, and must allocate channels and bandwidth to support the given QoS. As is known in the art, this task is quite burdensome, particularly if the application needs to deal with devices on different networks, such as streaming a video from a 1394 device to wireless screens that belong to different wireless networks. The application is typically required to use different interfaces provided by different networks to perform the streaming task.

The third weakness is that a UPnP application must be resident to execute any activities, and cannot merely schedule activities to start automatically. This lack of scheduling results in many applications being resident at the same time, and is less efficient than leaving the system to take care of requests for future activities, or requests for repetitive tasks.

### BRIEF SUMMARY OF THE INVENTION

It is an object of this invention to provide a system, method, and architecture to support the transfer of audio-video information via a UPnP network. It is a further object of this invention to provide a UPnP network management system that controls multiple-contender access to devices and sub-units of devices. It is a further object of this invention to provide a UPnP network management system that provides reliable communications at a given quality-of-service level. It is a further object of this invention to provide a UPnP network management system that provides for the scheduling of activities.

These objects and others are achieved by adding the following modules and systems to the UPnP architecture:

a resource management module that supports multiple contenders for a single device or its sub-units without races or hazards, and works with path managers to ensure path validity and integrity;

a path manager that provides source-to-sink path management, including ensuring path validity, integrity, and quality of service; and

an action manager that enables A/V applications to schedule activities.

The resource manager and the path manager are configured to manage device and network resources that are distributed in heterogeneous networks, such as resources distributed in networks using mixed Ethernet, 1394, 802.11, HyperLAN2, USB, HPNA, and are configured to ensure that a path across network boundaries will provide effective communications. Scheduling actions are the responsibility of the action manager. The action manager is a client of the resource manager and the path manager, and acts as an agent of the application. The resource manager and the path manager are configured as an integral part of UPnP framework, and as such, communicate with applications via HTTP messages.

### BRIEF DESCRIPTION OF THE DRAWINGS

The invention is explained in further detail, and by way of example, with reference to the accompanying drawings wherein:

FIG. 1 illustrates an example block diagram of a system comprising UPnP user control points (UCPs) that interact with multiple heterogeneous networks.

FIG. 2 illustrates an example block diagram of a system for bridging a non-IP network with UPnP user control points.

FIG. 3 illustrates an example block diagram of a UPnP architecture that supports the communication of time-sensitive information across multiple heterogeneous networks in accordance with this invention.

FIG. 4 illustrates an example flow diagram of a process for reserving device resources along a communication path in accordance with this invention.

FIG. 5 illustrates an example flow diagram of a process for setting up network segments along a communication path in accordance with this invention.

Throughout the drawings, the same reference numerals indicate similar or corresponding features or functions.

### DETAILED DESCRIPTION OF THE INVENTION

Copending U.S. patent application “UPnP ARCHITECTURE FOR HETEROGENEOUS NETWORK OF SLAVE DEVICES”, U.S. Ser. No. 09/736,999, filed Dec. 13, 2000 for Doreen Yining Cheng, Attorney Docket US008063, teaches a modification to the conventional UPnP architecture to facilitate UPnP device control and network management of non-UPnP-compatible devices on non-IP (Internet Protocol) networks, and is incorporated by reference herein. Each non-IP network is provided with UPnP proxy enabling and interfacing logic that effects the UPnP addressing, discovery, and description processes for each of the devices on one or more non-IP networks.

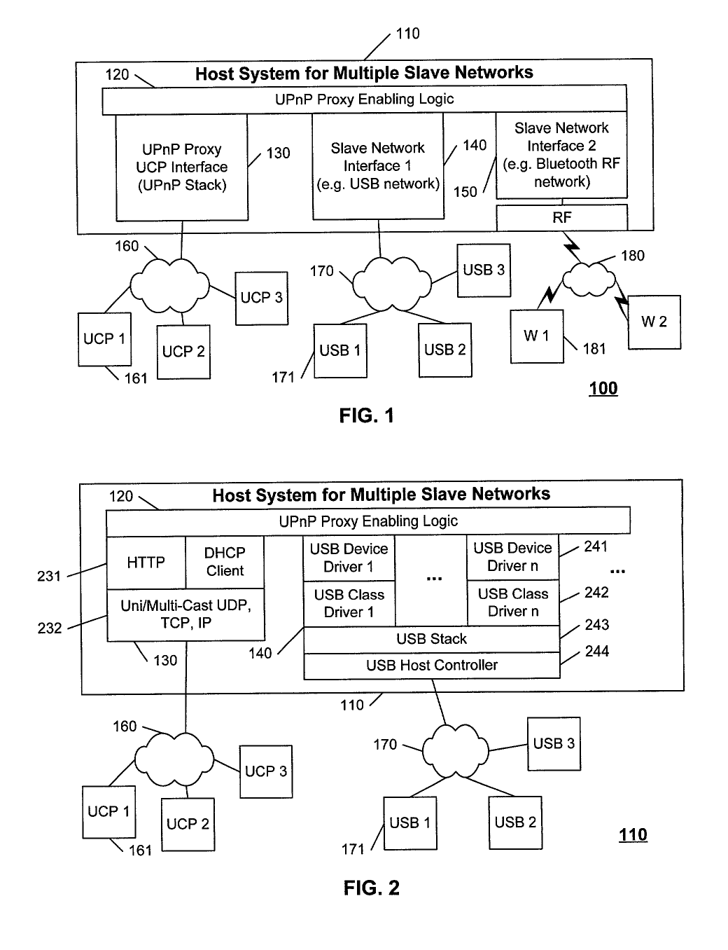

FIG. 1 illustrates an example block diagram of a system 100 as taught in this copending application, comprising UPnP controllers 161 on an IP network 160 that interact with devices 171, 181 on multiple heterogeneous networks 170, 180. For ease of reference, the UPnP controllers 161 are hereinafter referred to as user control points (UCPs), consistent with the commonly used term for such controllers, although the invention is applicable to any form of UPnP-compatible control entities.

The UPnP enabling logic 120 in a host system 110 interacts with the controlled, or slave, devices 171, 181 via slave network interfaces 140, 150, respectively. Although a single host system 110 is illustrated, one of ordinary skill in the art will recognize that the host system 110 may be distributed among a variety of devices. An example USB network 170 and a Bluetooth RF network 180 are illustrated, although the principles of this invention are applicable to virtually any network that facilitates control of devices on the network, including a HAVi-compatible network, such as an IEEE 1394 network, an 802.11 network, a HomeRF network, a Firefly network, a power line network, such as an X-10 network, and a Jini-compatible network.

The UPnP enabling logic 120 in the host system 110 effects the transformation and coordination of commands and messages between the UPnP user control points 161 and the slave devices 171, 181. For ease of reference, UPnP-compliant objects on the IP network 160 are referred to as UPnP objects, and device on the non-IP networks 170, 180 are referred to as non-UPnP devices.

FIG. 2 illustrates an example block diagram of a host system 110 for bridging a non-IP network 170, such as a USB network, with UPnP user control points 161. As illustrated, the UPnP enabling logic 120 interacts with the UCPs 161 on the IP network 160 through a UPnP stack 130 that includes HTTP 231 on top of TCP/IP and UDP/IP 232, discussed further below. The UPnP enabling logic 120 also interacts with the slave network interface 140 to effect control and messaging with the slave devices 171. In this example, the USB network interface 140 includes device drivers 241, class drivers 242, a USB stack 243, and a USB Host controller 244, consistent with existing USB standards. As discussed further below, the slave network interface 140 provides the UPnP enabling logic 120 with information about each device 171 on the network 170, the current status (connected/disconnected/standby/etc.) of each device 171, current capabilities of each device 171, and so on.

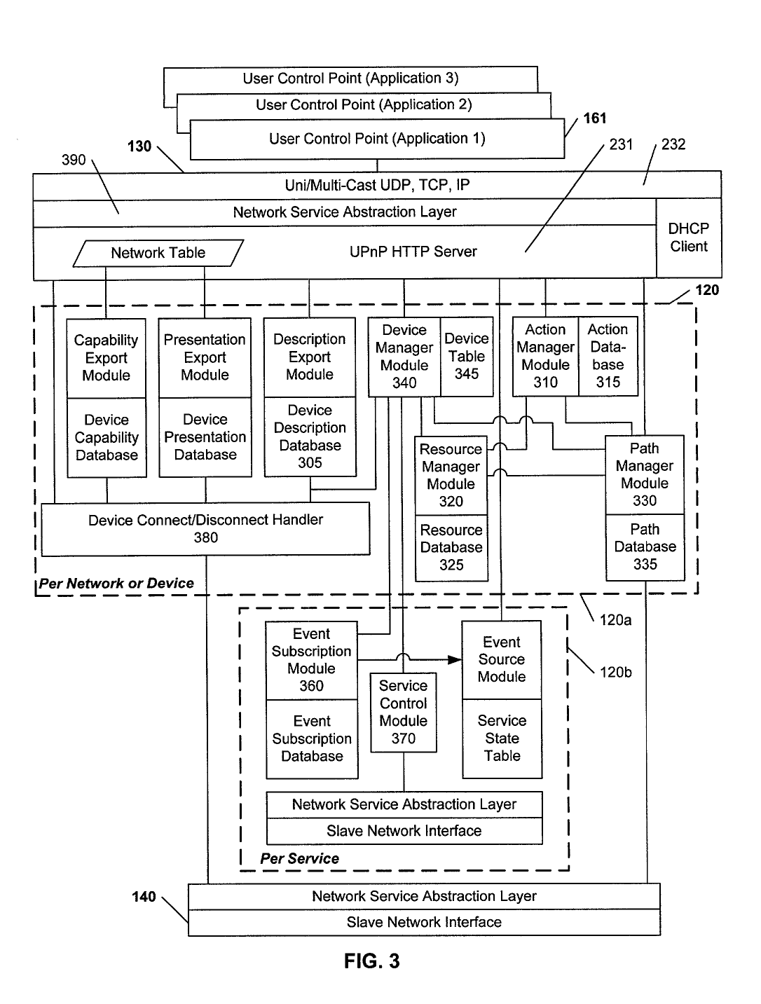

FIG. 3 illustrates an example block diagram of a UPnP architecture in accordance with this invention. FIG. 3 is derived from the aforementioned copending U.S. patent application. This invention provides the necessary features and functions to the enabling logic 120 to facilitate efficient and effective transfer of audio-video information, or other time-sensitive information among devices on heterogeneous networks. Specifically, the action management module 310, the resource management module 320, and the path management module 330, and their associated databases 315, 325, 335, respectively, are provided to support the communication of A/V and other time-sensitive information via a UPnP-enabled heterogeneous network. The UPnP network management system of this invention comprises one or more UPnP proxy enabling logic blocks 120 that are configured to to control multiple-contender access to devices and sub-units of devices; to provide reliable communications at a given quality-of-service level, as required; and to provide for the scheduling of activities, as detailed below.

For ease of understanding, only those functions of the UPnP proxy enabling logic 120 that are affected by the features or functions of this invention are discussed herein. Also for ease of understanding, the following definitions are provided.

Device Resources, or simply Resources: Device resources include devices and their subunits. For example, a VCR device and its sub-units such as tuner, clock, timer, and tape transport are device resources.

Network Resources. Network resources include channels and bandwidth.

Path: A path is a sequence of ordered, network-connected device resources starting from a source resource and ending at a sink resource. An A/V stream can flow through a path following the order of the sequence.

A/V action, or simply Action: An A/V action corresponds to a specific type of A/V stream, or other time-sensitive stream, flowing through a path, starting at a specific time, ending at another specific time, and possibly occurring periodically. For example, a recording action provides an MPEG2 video stream from the VCR tuner to the PC disk starting at 3:30 pm, ending at 5:00 pm every day.

In accordance with this invention, the scheduling of an A/V action is effected in the following sequence:

1. Reserve all the resources along the path of the action. The reservation takes effect starting at the time when the action is to be executed, and lasts for the time duration of the action;

2. Set up the connections and allocate network resources along the path of the action according to its QoS requirements; and

3. Schedule the action at the specified time.

In a preferred embodiment, an application is provided the option of managing resource reservation, path setting, and scheduling activities directly, or it can request the action manager 310 to manage these activities. By providing an action manager 310, the application can be free from the concerns of detailed resource management and path management. Preferably, network resources are allocated and the path is set up immediately prior to the time that an action is to take place, to maximize the use of network resources, although device resources can be reserved well before the effective time by the action manager 310, or the application.

In a preferred embodiment, each path manager has a corresponding peer resource manager. Together, the resource and path managers manage the device resources and network resources in a particular network, and ensure path validity and integrity. For example, a resource manager of a 1394 network manages the device resources in the network, and the peer path manager manages the network resources that connect the device resources. Resource managers ensure that device resources along an entire path are either all reserved, or all released, by communicating with each other. Similarly, path managers ensure that the entire path is setup, also by communicating with each other. The path managers also inform their corresponding peer resource managers to release network resources in case of tear-down.

In a preferred embodiment of this invention, the conventional UPnP specification is amended to include HTTP request and response commands to support resource management, path management, and scheduling. The resource management commands include RESERVE and RELEASE, with a message body that identifies the path whose resources are to be reserved, and the starting time and the ending time for the reservation. The path management commands include SETUP and TEARDOWN, with a message body that includes the path, the type and characteristics of the data stream, the quality-of-service (QoS) requirements of the stream, and the starting time and the ending time for the path setup. The scheduling commands include SCHEDULE and UNSCHEDULE, with a message body that includes the path, the starting time (including ‘now’), the ending time of the action, the type and characteristics of the data stream, and the quality-of-service QoS requirements of the stream. The scheduling commands allow an application to exit the network once the scheduling command is submitted.

To communicate the availability of the facilities of this invention, the device description database 305 contains the location (as a Universal Resource Locator (URL)) of the action manager 310, the resource manager 320, and the path manager 330 associated with each device or service. In a preferred embodiment, the Device Manager Module 340 automatically adds these URLs to the device description database 305.

The HTTP Server 231

At initialization time, the HTTP server 231 creates one thread for every resource manager 320, path manager 330, and action manager 310. Preferably, one manager of each type is set for every network, and a configuration file (not illustrated) is used to indicate that a particular network will use none or one or more managers of a particular type. The HTTP server 231 also recognizes and dispatches requests, discussed further below, that are directed to the resource managers 320, path managers 330, and action managers 310.

The Resource Manager Module 320

A primary function of the resource manager module 320 is to avoid race conditions when multiple applications try to use the same device or sub-unit. Preferably, the resource manager 320 is network specific, and is responsible for managing the resources, or a subset of the resources, in the corresponding network. For example, in a UPnP environment composed of 1394 devices and 802.11 devices, at least two resource manager modules 320 are provided, one for 1394 devices and one for 802.11 devices. The 1394 resource manager is responsible for managing 1394 devices and their sub-units, and the 802.11 manager is responsible for 802.11 devices and their sub-units.

Because the resource managers 320 manage resources that are distributed in heterogeneous networks, such as resources distributed in networks using mixed Ethernet, 1394, 802.11, USB, HPNA, and so on, each resource manager 320 is configured to ensure that a path across network boundaries will operate properly. The resource manager 320 ensures an all-or-none reservation, such that a reservation is established if and only if all of the entities along the path, from source to sink, can be suitably configured and reserved for the intended transaction. The resource manager 320 is an integral part of the UPnP framework and communicates with an application via HTTP messages that are communicated via the HTTP server 231.

In operation, an application or a UPnP system component, such as an action manager 310, issues a resource reservation request. By doing so, it becomes a requester. Every resource manager who receives a reservation request (referred to as an “active manager” below) must ensure the validity of a path, and must participate in the all-or-none reservation process. For this reason, all requests such as RESERVE, RELEASE, SETUP, and TEARDOWN indicate the entire path along which the device and network resources are to be managed. A path is valid only if all the device resources along the path are reachable. A device resource is reachable if it is under the responsibility of the active manager, or if it has a resource manager and the resource manager is reachable. A resource manager is reachable only if it responds to a request from the active manager before a defined time deadline elapses, via, for example, an acknowledgment message. The above definition of reachability and path validity also applies to network resources and path managers.

To avoid dead lock, a requester reserves all resources along the path of an action. If any resource is not available, the reservation fails. As an example, before trying to stream video from a VCR to a TV display, the application first reserves the VCR tuner and the TV display. If it cannot reserve both, it does not start the streaming.

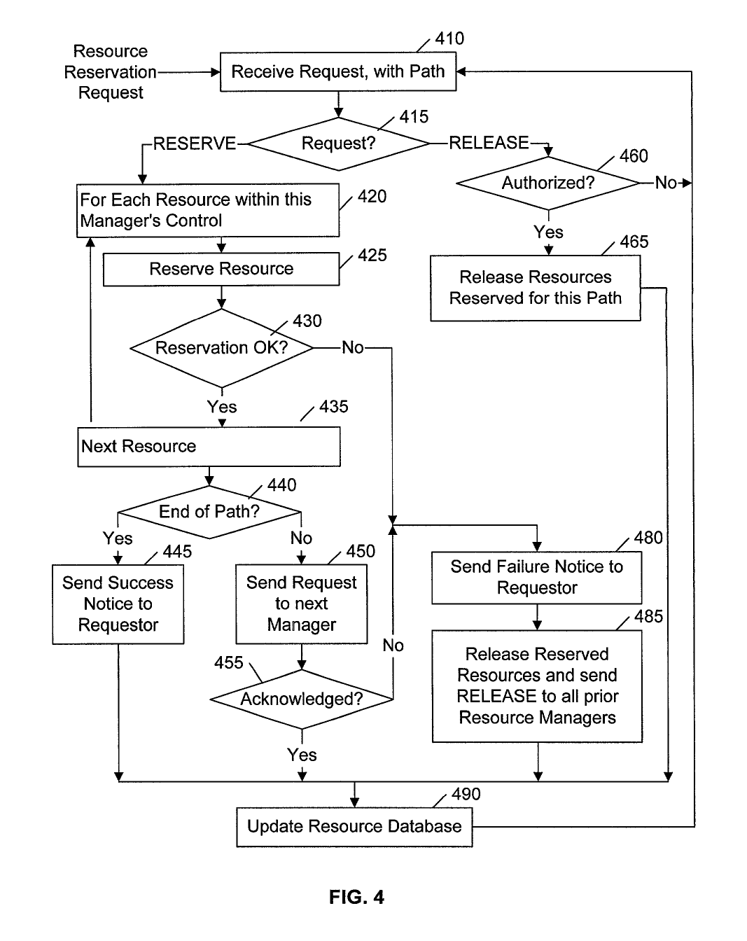

FIG. 4 illustrates an example flow diagram of the primary logic of a reservation process, suitable for use by the example resource manager 320 of FIG. 3. A requester sends a request, which may be either a “RESERVE” message or a “RELEASE” message, to any known resource manager. Each resource manager executes a continuous loop, waiting to receive the message, at 410.

If, at 415, the message is a RESERVE request, the manager attempts to reserve all the resources along the path and under its responsibility, via the loop 420-435. At 425, the receiving resource manager first tries to find a resource yet to be reserved. If found and the resource is under the responsibility of the receiving resource manager, it tries to reserve the resource. If the reservation is successful, at 430, it modifies the reservation request to indicate that this resource has been reserved, and proceeds to find the next yet-to-be-reserved resource. The process 420-435 is repeated until the resource manager has either successfully reserved all the resources in the path and under its responsibility or it has failed to reserve one such resource. In the case of a failed reservation, at 430, the resource manager sends a FAILED message to the requester, at 480. The resource manager then releases all the resources that it has reserved for this task, and sends a RELEASE message to all prior resource managers, terminates the reservation for this path, at 485, and updates the resource management database 325, at 490.

If, via the loop 420-435, the resource manager has successfully reserved all the resources under its responsibility, it will check, at 440, whether there are still more resources to be reserved. If not, the resource manager sends a SUCCESS message to the requester, at 445, updates its corresponding resource management database 325, at 490, and terminates the reservation for this path. If, at 440, there are more yet-to-be-reserved resources in the path, it marks the resources that it just reserved as “reserved”, forwards the request to the next resource manager, at 450, and waits for an acknowledgement message from the next resource manager. If, at 455, it does not receive an acknowledgement message before a timeout, it sends a FAILED message to the requester, at 480, releases all the resources it has reserved for the request, sends a RELEASE message to all the prior resource managers, updates its corresponding resource management database 325, at 490, and terminates the reservation for this path. If, at 455, the resource manager receives an acknowledgement message before a time out, the resource manager updates its corresponding resource management database 325, at 490, loops back to 410, and repeats the above process for each subsequent request.

If, at 415, the message is RELEASE, the resource manager first checks whether the requester is qualified to release the resources listed, at 460. A requester is qualified to release a resource if the requester is another resource manager 320, a path manager 330, an action manager 310, or the owner (the application for which the resources are reserved) of the resources. If, at 460, the requester is not qualified to release the resources, the request is ignored. Optionally, a FAILED message can be sent to the unqualified requester. If, at 460, the requester is qualified, the resource manager releases the resources under its responsibility that have been reserved for the path, at 465, and updates its corresponding resource management database 325, at 490. The resource manger then goes back to 410 to serve a new request.

Additionally (not illustrated), to assure that resources are released, even if a requester does not explicitly release the resource, the resource manager 320 is configured to release all resources at the expiration of the reservation time period, or soon thereafter.

In addition to, and/or in conjunction with, the above described reservation activities of FIG. 4, the resource manager 320 of FIG. 3 in a preferred embodiment of this invention also performs the following functions.

The resource manager 320 creates and maintains the resource management database 325, which is preferably implemented as an in-core data structure such as a table. For each resource, the database keeps information about whether the resource is reserved or not, the owner of the resource, the starting and ending time of the reservation, periodicity of the reservation, and the resource management related control functions. If a reservation is made by a UPnP system component on behalf of an application, the information related to the component is also recorded.

When the resource manager 320 receives a RESERVE request, it attempts to reserve the requested resources, while checking path validity and enforcing the all-or-none reservation as described in the flowchart of FIG. 4. If its portion of the reservation succeeds, the resource manager 320 records the reservation in the database 325. If the resource provides resource management control functions, the resource manager also forms an XML/SOAP message and sends it to the corresponding Service Control Module 370.

The resource manager 320 also provides an interface for receiving notification about the arrival or departure of a resource. When it receives an arrival notification, it creates an entry in the database 325, fetches the description of the resource, extracts the information about the resource management related control functions for the resource, and enters the information into the database 325. When the resource manager 320 receives a departure notification, it can either delete the entry, or mark the entry to indicate the departure of the resource. By marking the entry, the processing required to recreate the entry when the resource returns is avoided.

Additionally, the resource manager 320 provides an interface for a UPnP system component, such as the action manager 310 or path manager 330, to reserve or release resources without going through HTTP messaging.

The resource manager 320 also provides administrative and notification functions. The resource manager 320 provides an interface for queries into its database 325, for example, a query regarding whether a requester is the owner of a particular resource. It also subscribes to the events that are relevant to resource management for all resources under its responsibility, via the event subscription module 360. When it receives notification of an event, the resource manager 320 updates the database 325, and informs the owner, if appropriate.

The Path Manager Module 330

The path manager 330 is responsible for managing network resources and device connection objects. Device connection objects include, for example in IEC61883, device plugs and sub-unit plugs. It connects the device resources along the path, and allocates network resources to ensure source-to-sink setup and quality of service. As a result, in a preferred embodiment of this invention, an application only needs to specify the needs and characteristics of an A/V stream to the path manager 330, without any knowledge of the characteristics of the resources needed. An application, or a UPnP system component, such as an action manager 310, can issue a path setup request. By doing so, the application or the component becomes a requester. A path setup request includes the path to be setup, the starting and ending time when the path is needed, the type and characteristics of the stream, and QoS requirements of the stream. As in the case of the device resource manager 320, the path manager 330 is configured to assure an all-or-none path integrity. If any connection cannot be made, or any network resources cannot be allocated, the states of all the objects related to the path are reset and all device resources and network resources are released.

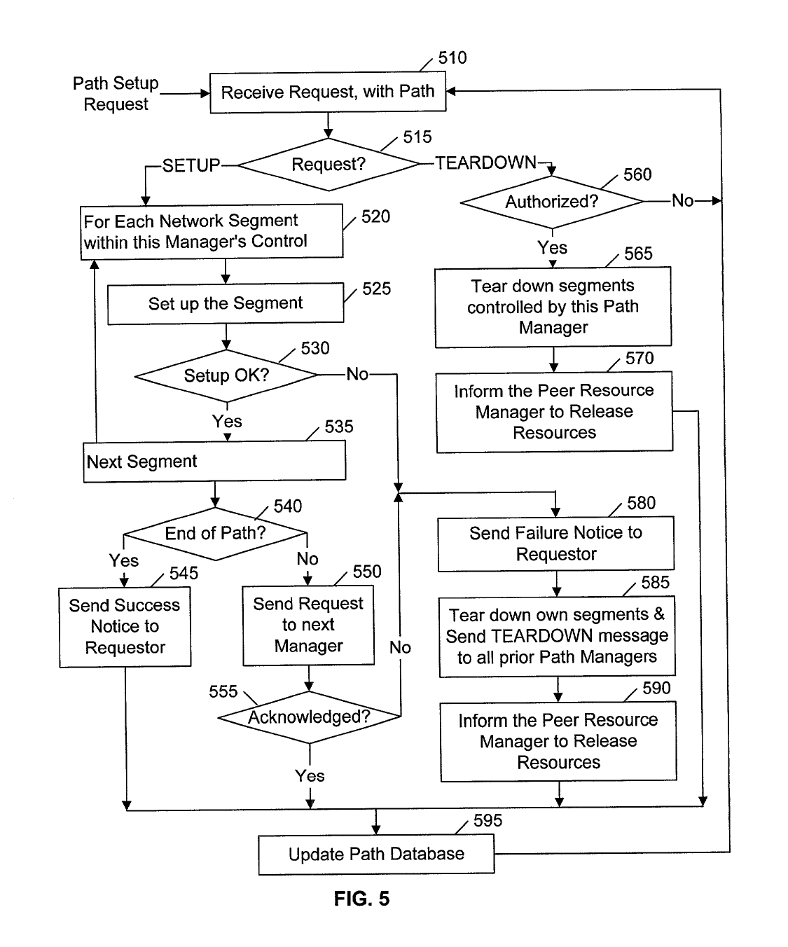

In a preferred embodiment, a path manager 330 executes a continuous loop as shown in FIG. 5. Since the logic of the loop is similar to the logic of the loop in FIG. 4, details common to both are not repeated here. A requester sends the request to any known path manager 330. If the request is SETUP, the receiving path manager 330 attempts to setup all the segments in the path that are under its responsibility, via the loop 520-535. If all these segments can be successfully set, the path manager marks the segments it just set up as “Set”, forwards the message to the path manager of the next as-yet-unset segment and waits for the next path manager to respond, at 550. If no response is received before a time out, at 555, the path manager sends a failure message to the requester, at 580, tears down all the network segments under its responsibility, and sends a TEAR DOWN message to all prior path managers who have set up the segments for this path, at 585. It updates the corresponding path management database at 595 before looping back to 510. Tearing down a path includes resetting all device-related objects in the path and releasing all network resources for the path. The process continues until the entire path is set without a failure. The path manager 330 that detects the end after its own successful setup, at 540, sends a success response back to the requester, at 545, updates the corresponding path management database at 595, and goes back to 510 to serve a new request.

If, in the process, a path manager 330 cannot set all the segments under its responsibility, at 530, it sends a Failure notice to the requestor at 580, releases all the network resources under its responsibility, and sends a TEAR DOWN message to all prior path managers who have set up the segments for this path, at 585. It also informs the peer resource manager 320 about the tear down, via the aforementioned release request, at 590, updates the corresponding path management database at 595, and terminates the setup process by going back to the beginning of the loop to serve a new request. Failure of allocation can occur when a path manager cannot satisfy the lower limit of the network resource requirements of the request, that is, when the total bandwidth available is less than the minimum bandwidth required.

If, at 515, the request is a TEAR DOWN request, the path manager 330 first checks whether the requester is qualified to tear down the path. A requester is qualified to tear down a path if it is a resource manager 320, another path manager 330, an action manager 310, or the owner of the path. An owner of a path owns all the resources in the path at the time of the request, and for the time duration indicated in the request. If the requester is qualified, the path manager 330 tears down the segment under its responsibility, at 565, informs its peer resource manger to release resources already reserved for this path, at 570, and updates the corresponding path management database, at 595, before looping back to 510.

In addition to, and/or in conjunction with, the above described path creation process, the path manager 330 in a preferred embodiment of this invention performs the following functions.

The path manager 330 creates and maintains the path database 335. The path database 335 contains the information needed for setting up a path and satisfying the QoS requirements. For each path, the path manager 330 records the state and the capability of the resources, the network resources allocated, the owner requester, the owner action, and so on.

Upon receipt of a SETUP request, the path manager 330 attempts to setup the segments of the path under its responsibility and ensures path setup integrity, as detailed above. The path manager 330 records the information about the path in the database 335 if it is successful in its portion of setup. A path manager 330 of a particular network understands how to setup a path in this network. For example, a path manager of a 1394 network will use “plugs”, and follow the rules associated with the 1394 standards and protocols, such as IEC61883, regarding the connection of devices and/or their sub-units via these plugs.

For networks that can guarantee QoS, such as 1394 networks, the path manager 330 allocates network resources to satisfy the QoS requirements from the requester. For networks that cannot guarantee QoS requirements, such as IP/Ethernet, the path manager 330 allocates the best facility available. For example, the path manager 330 tries to use DifServe-like facilities in an Ethernet network.

The path manager 330 provides an interface for a UPnP system component, such as a resource manager 320, to pass a list of resources that have been released. When the path manager 330 receives such a list, it tears down the path that contains these resources and updates the database 335.

The path manager 330 also provides an interface for receiving notification about the arrival or departure of a resource. When it receives an arrival notification, the path manager 330 creates an entry in the database, fetches the description of the device resources, extracts the information about the path management related control functions, and enters the information into the database 335. When it receives a departure notification, the path manager 330 either deletes the entry, or marks the entry to indicate the departure of the resource.

The path manager 330 also provides an interface for querying the path database 335.

The Action Manager Module 310

The action manager module 310 enables an application to schedule actions, leaving the action manager 310 to take care of the action requests. The action manager 310 also frees an application from details of resource management, path setup, and action management. In a preferred embodiment, a scheduling request includes the path, the starting and ending time of the action, the type and characteristics of the A/V streams, and QoS requirements of the stream.

The action manager 310 performs the following actions.

The action manager 310 creates and maintains the action database 315. The database 315 records the information regarding how to manage an action. The information includes the path, the starting and ending time, and the application that scheduled the action, the type and characteristics of the A/V streams, and QoS requirements of the stream. For efficiency, the database 315 preferably organizes the actions in a time queue.

When the action manager 310 receives a SCHEDULE request, it sends a RESERVE request to the resource manager 320 of a resource in the path. When it receives a success response, if the action starting time is “now”, the action manager 310 sends a SETUP request to a path manager in the path. If it receives a success response, it starts the requested action. If the action starting time is in the future, the action manager 310 enters the action into the database 315 to wait for the execution time to arrive. Because resource managers and path managers properly release all device and network resources upon a failure, action managers do not need to initiate the release.

The action manager 310 gives itself sufficient length of time to setup the path required by an action before the action is to be scheduled. When it is the time to set up a path, as indicated by a periodic check of the database 315 or as a response to a timer event, the action manager 310 checks whether the requesting application still owns all the resources needed at this time. The execution fails if the owner (the reserver of the resource) has been changed, via, for example, a preemption. If the application still owns all needed resources, the action manager 310 instructs the path manager 330 to setup the path of the action. After the path is successfully set, the action manager 310 starts the action. If path setting fails, the execution fails. Since the path managers 330 inform the resource managers 320 in case of failure, the action managers 310 do not need to do so. The action manager 310 either informs the application about the execution result, if the application still exists, or logs the result for future inspection.

Optionally, preemption may be implemented, wherein an application may preempt scheduled actions. If chosen by an application, the action manager 310 participates in preemption negotiation in behalf of the application that scheduled the action. If the negotiation results in giving up some resources, the action manager informs the application, if the application still exists, or logs the case for future inspection. Meanwhile, if the preemption happens before starting the path set up, the action manager 310 sends a RELEASE request to all resource managers 320 that have reserved resources for the preempted action. Otherwise, the action manager 310 sends a TEAR DOWN request to all path mangers that have set up for the path. The path managers in turn inform their corresponding peer resource managers to release reserved resources. In the case where a resource is preempted by an external event, for example, where a tuner is manually changed to receive a channel that is different than the one in a reservation, the corresponding resource manager receives a notification about the event. The resource manager notifies the owner of the resource about the event.

In a preferred embodiment, the action manager 310 is implemented in two threads: the producer thread and the consumer thread. The producer thread responds to the SCHEDULE and UNSCHEDULE requests. Upon receiving a SCHEDULE request, the producer thread of the action manager 310 tries to reserve the required resources. If an action is to be executed at the current moment and all resources are successfully reserved, the producer thread also starts to set up the path, and to schedule the action immediately. If the request is for a future time, the producer thread puts the activity into the database 315 upon successful reservation. When the scheduled time of path setup for an action arrives, the consumer thread pulls all the activities that should be executed at this time out of the database 315, and effects their execution.

In a preferred embodiment of the Device Connect/Disconnect Handler 380, the handler 380 inserts an entry to the description of a device and/or service in the description database 305. This entry preferably indicates the URL of the resource manager 320, path manager 330, and action manager 310 that are responsible for the device/service.

The Device Manager 340

When the information transfer corresponding to the reserved path, above, commences, the device manager 340 is configured to enforce rules regarding the right to execute state-changing requests, in order to prevent race conditions that may occur when multiple applications try to change the state of the same resource. The right to execute is enforced in two steps: reservation and gate keeping:

Reservation, an application has the right to execute a state-changing command if and only if it has already obtained the ownership of the resource for the time of the command execution. To become the owner of a resource, the application must successfully reserve the resource through the resource manager 320. After an action manager 310 receives a schedule command, it will first reserve the resources needed by the action to ensure that the requesting application owns the resources along the path of the action at the time of action execution.

Gate Keeping: Commands that access resources are executed through the device manager module 340. Before the device manager 340 passes a state-changing command to the resource, the device manager 340 checks whether the requester has the right to do so. Each device, and consequently all the associated device resources and network resources, has one resource manager and one path manager responsible for managing its device resources, network resources, and network connection objects. In a preferred embodiment, only the responsible resource manager has the right to reserve any device resources and only the responsible path manager has the right to allocate network resources and manipulate the connection objects. In addition, only the owner application or the action manager representing the application can execute an action. This will cause an application that has not reserved all the resources to get a failure response when it tries to execute the action, even if a device does not provide reservation capabilities of its own. In a preferred embodiment, any requester has the right to change a state of a device during periods in which the resource is not reserved. The resultant state, however, will be preempted as required when the time for a pre-scheduled state-change for a reserved resource arrives.

In a preferred embodiment, the device manager 340 provides the following functions.

The device manager 340 creates/deletes the threads for a service due to arrival/departure of a device, and notifies the resource manager 320 and the path manager 330 regarding the change.

When the device manager 340 receives a control command that will change the state of a target service, the device manager 340 first checks whether the requester has the right to do so. It will pass the command to the service only if the requester is qualified. In a preferred embodiment, the device manager 340 first queries the reservation state of a device or network resource. If the request cannot be satisfied, the device manager 340 sends a “failed” response to the requester. A request fails if the state is not changeable, or if the relevant state value equals to the requested value, for example, if the resource is already in a reserved state, or if the request amount exceeds the supply, for example, if there is insufficient bandwidth remaining. Otherwise, the device manager 340 sets the value of the state to the requested value and sends a “success” response to the requester.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. A system for facilitating communication of time-sensitive information via a UPnP network, comprising:
a management system that is configured to reserve a plurality of resources to form a plurality of reserved resources along a path between a source of the time-sensitive information and a sink of the time-sensitive information before initiating the communication of the time-sensitive information.

2. The system of claim 1, wherein
the path between the source and the sink extends across a plurality of networks, the source being on a first network of the plurality of networks, and the sink being on a second network of the plurality of networks.

3. The system of claim 2, wherein
the management system includes a plurality of resource management modules,
each resource management module being associated with a corresponding network of the plurality of networks, and being configured to reserve one or more device resources of the plurality of reserved resources on the corresponding network,
the resource management module that is associated with the first network is configured to communicate a reservation request to another resource management module to reserve one or more device resources of the plurality of reserved resources on another network of the plurality of networks.

4. The system of claim 3, wherein
each resource management module is configured as an integral part of a UPnP framework, and communicates with applications via HTTP messages.

5. The system of claim 3, wherein
the another resource management module in the another network is configured to reserve the one or more device resources only if a subsequent resource manager, along the path from the first network to the second network, is reachable by the another resource management module.

6. The system of claim 3, wherein
each resource management module is configured to communicate a release message to a prior resource management module along the path when a requested reservation cannot be effected, and
the prior resource management module releases associated device resources of the plurality of reserved resources upon receipt of the release message.

7. The system of claim 3, wherein
the management system further includes a plurality of path management modules,
each path management module being associated with a corresponding network of the plurality of networks, and being configured to reserve one or more network resources on the corresponding network,
the path management module that is associated with the first network is configured to communicate a reservation request to another path management module to reserve one or more network resources on another network of the plurality of networks, and
each resource management module and path management module is configured as an integral part of a UPnP framework, and communicates with applications via HTTP messages.

8. The system of claim 2, wherein
the management system includes a plurality of path management modules,
each path management module being associated with a corresponding network of the plurality of networks, and being configured to reserve one or more network resources on the corresponding network,
the path management module that is associated with the first network is configured to communicate a reservation request to another path management module to reserve one or more network resources on another network of the plurality of networks.

9. The system of claim 8, wherein
at least one of the path management modules is configured to reserve a network resource having a specified quality-of-service.

10. The system of claim 1, further including
a device manager module that is configured to prevent state-changing commands being communicated to a device resource of the plurality of reserved resources, except by a requester that reserved the plurality of reserved resources.

11. The system of claim 1, further including
an action manager module that is configured to communicate a reservation request to the management system, based on a schedule request from an application program, and to communicate a path setup request to the management system at a time corresponding to a scheduled time contained in the schedule request.

12. A method for facilitating communication of time-sensitive information via a UPnP network, comprising:
defining a path between a source of the time-sensitive information and a sink of the time-sensitive information,
reserving a plurality of resources to form a plurality of reserved resources along the path.

13. The method of claim 12, wherein
the path between the source and the sink extends across a plurality of networks, the source being on a first network of the plurality of networks, and the sink being on a second network of the plurality of networks.

14. The method of claim 13, wherein
reserving the plurality of resources includes:
reserving resources of the plurality of resources that are associated with a network along the path,
communicating a reservation request to an other network along the path,
reserving the resources associated with the other network, and
repeating the communicating of the reservation request to each other network along the path and reserving the resources associated with each other network until each resource of the plurality of resources is reserved along the path.

15. The method of claim 14, wherein
the resources are reserved at each other network only if receipt of the reservation request is acknowledged by a subsequent other network along the path.

16. The method of claim 14, further including
communicating a release message to a prior network along the path when a requested reservation cannot be effected, and
releasing associated device resources of the plurality of reserved resources at the prior network upon receipt of the release message.

17. The method of claim 13, further including:
reserving one or more network resources on the first network,
communicating a reservation request to an other network, and
reserving one or more network resources on the other network of the plurality of networks.

18. The method of claim 17, wherein
the reservation request includes a specified quality-of-service.

19. The method of claim 12, further including
preventing state-changing commands being communicated to a device resource of the plurality of reserved resources, except by a requester that reserved the plurality of reserved resources.

20. The method of claim 12, further including:
communicating a reservation request to a management system, based on a schedule request from an application program, and
communicating a path setup request to the management system at a time corresponding to a scheduled time contained in the schedule request.
